(19) United States
(12) Patent Application Publication
(10) Pub. No.: US 2025/0005369 A1
(43) Pub. Date: Jan. 2, 2025

(54) VALUE-BASED ACTION SELECTION ALGORITHM IN REINFORCEMENT LEARNING

(71) Applicant: Telefonaktiebolaget LM Ericsson (publ), Stockholm (SE)

(72) Inventors: Zhiqiang QI, Beijing (CN); Jingya LI, Göteborg (SE); Xingqin LIN, San Jose, CA (US); Anders ARONSSON, Uddevalla (SE); Hongyi ZHANG, Göteborg (SE); Jan BOSCH, Hovås (SE); Helena Holmström OLSSON, Bunkeflostrand (SE)

(73) Assignee: Telefonaktiebolaget LM Ericsson (publ), Stockholm (SE)

(21) Appl. No.: 18/700,979

(22) PCT Filed: Jan. 14, 2022
(86) PCT No.: PCT/CN2022/072078

§ 371 Date: Apr. 12, 2024

(51) Int. Cl. G06N 3/092

(52) U.S. Cl. CPC G06N 3/092

(57) ABSTRACT

A method and agent for reinforcement learning. The method may include evaluating a consequence of a previous action. Evaluating the consequence may include performing a comparison of one or more current monitored parameters (e.g., immediate reward, accumulated reward, average reward, and/or current key performance parameters) to one or more previous monitored parameters. The method may include, based on the evaluated consequence of the previous action, determining a subset of potential next actions. For a positive consequence, the determined subset of potential next actions may include only potential next actions that are likely to have the consequence as the previous action (e.g., based on a dot product of or angle between vectors of the previous action and the potential next action). The method may include selecting an action from the determined subset of potential next actions. The method may include performing the selected action.

### TECHNICAL FIELD

This disclosure relates to reinforcement learning.

### BACKGROUND

### Reinforcement Learning

Reinforcement learning (RL) is a type of machine learning (ML) that focuses on learning what to do (i.e., how to map the current scenario into actions) to maximize the numerical payoff signal. The learner is not told what tasks to do. Instead, the learner must experiment to find which actions would yield the most desirable results.

Reinforcement learning is distinct from supervised and unsupervised learning in the field of machine learning. Supervised learning is performed from a training set with annotations provided by an external supervisor. That is, supervised learning is task-driven. Unsupervised learning is typically a process of discovering the implicit structure in unannotated data. That is, unsupervised learning is data-driven. Reinforcement learning is another machine learning paradigm. Reinforcement learning provides a unique characteristic: the trade-off between exploration and exploitation. In reinforcement learning, an intelligence can benefit from prior experience while still subjecting itself to trial and error, allowing for a larger action selection space in the future (i.e., learning from mistakes).

Although the designer sets the reward policy, that is, the rules of the game, the designer does not give the model hints or suggestions on how to solve the game. It is up to the model to figure out how to perform the task to maximize the reward, starting from totally random trials and finishing with sophisticated tactics and superhuman skills. By leveraging the power of search and many trials, reinforcement learning is currently the most effective way to hint machine's creativity. In contrast to human beings, artificial intelligence can gather experience from thousands of parallel gameplays if a reinforcement learning algorithm is running on a sufficiently powerful computer infrastructure.

FIG. 1 illustrates the basic concept and components of an RL system 100. The basic reinforcement learning is modeled as a Markov decision process. The RL system 100 includes an RL agent 102 (or “agent” for short), a set of states S, and a set of actions A per state. By performing an action a, the RL agent 102 transitions from state to state and receives an immediate reward after taking the action.

As shown in FIG. 1, the RL agent 102 interacts with the environment 104. At a given time t, the RL agent 102 receives the current state sₜ and reward rₜ. The RL agent 102 then chooses an action aₜ from the set of available actions for the current state sₜ. The action aₜ is then sent to the environment 104. After the action is performed, the environment 104 moves to a new state Sₜ₊₁, and the reward rₜ₊₁ associated with the transmission (sₜ, aₜ, sₜ₊₁) is determined. The goal of the RL agent 102 is to learn a policy that maximizes the expected cumulative reward. The policy may be a map or a table that gives the probability of taking an action a when in a state s. The reward functions in the algorithm are crucial components of reinforcement learning approaches. A well-designed reward function can lead to a more efficient search of the strategy space. The use of reward functions distinguishes reinforcement learning approaches from evolutionary methods, which perform a direct search of the strategy space led by iterative evaluation of the entire strategy.

### Q-Learning

Q-learning is a reinforcement learning algorithm to learn the value of an action in a particular state. Q-learning does not require a model of the environment, and, theoretically, Q-learning can find an optimal policy that maximizes the expected value of the total reward for any given finite Markov decision process. The Q-algorithm is used to find the optimal action/selection policy:

$$Q : S \times A \to ℝ . \qquad ( Eq . 1 )$$

FIG. 2 illustrates the basic flow of a Q-learning algorithm 200. Before learning begins, in a step 202, Q is initialized to a possibly arbitrary value. Then, at each time t, the agent selects an action aₜ in a step 204, performs the action in a step 206, observes a reward rₜ in a step 208, enters a new state Sₜ₊₁ (that may depend on both the previous state sₜ and the selected action), and Q is updated in a step 210 using the following equation:

$${Q}^{new} ( {s}_{t} , {a}_{t} ) ← Q ( {s}_{t} , {a}_{t} ) + α \cdot ( {r}_{t} + γ \cdot {max}_{a} Q ( {s}_{t + 1} , a ) - Q ( {s}_{t} , {a}_{t} ) ) , \qquad ( Eq . 2 )$$

where α is the learning rate with 0<α≤1 and determines to what extent newly acquired information overrides the old information, and γ is a discount factor with 0<γ≤1 and determines the importance of future rewards. As shown in FIG. 2, the result at the end of the training is a good Q*table.

### Deep Q-Learning

A simple way of implementing a Q-learning algorithm is to store the Q matrix in tables. However, this can be infeasible or not efficient when the number of states or actions becomes large. In this case, function approximation can be used to represent Q, which makes Q-learning applicable to large problems. One solution is to use deep learning for function approximation. Deep learning models consist of several layers of neural networks, which are in principle responsible for performing more sophisticated tasks like nonlinear function approximation of Q.

Deep Q-learning is a combination of convolutional neural networks with the Q-learning algorithms. Deep Q-learning uses a deep neural network (DNN) with weights θ to achieve an approximated representation of Q. In addition, to improve the stability of the deep-Q learning algorithm, a method called experience replay was proposed to remove correlations between samples by using a random sample from prior actions instead of the most recent action to proceed. After performing experience replay, the agent 102 selects and executes an action according to an ε-greedy policy. ε defines the exploration probability for the agent 102 to perform a random action. The details of the ε-greedy policy are described in the following sections.

FIG. 3 shows a schematic of a deep Q-learning system 300. As shown in FIG. 3, in deep Q-learning, the state is provided as input of the DNN, and the Q-value of all possible actions is returned as output of the DNN. In the deep Q-learning system 300 shown in FIG. 3, the agent 102 stores all previous experiences in memory, and the maximum output of the Q-network determines the following action. In this situation, the loss function is the mean squared error of the current and target Q-values Q′. The deep-Q network employs a deep convolutional network to estimate the current value function, while another network is utilized separately to compute the goal Q-value. Q(Sₜ, Aₜ) denotes the current value network's output, and the value function is used to evaluate the current state-action pair. Q(Sₜ₊₁, α) denotes the target network value output, specifically the target Q value. Equation (2) gives the Q-value updating equation obtained from the Bellman equation. By minimizing the mean square error between the present and target Q-values, the network parameters are adjusted.

### Multi-Armed Bandit Problem

In reinforcement learning, the multi-armed bandit problem is used to define the concept of decision-making under uncertainty. In a multi-armed bandit problem, an agent (learner) chooses one of k possible actions and receives a reward based on the action selected. Multi-armed bandits are also used to describe basic ideas in reinforcement learning such as rewards, time steps, and values.

When an agent chooses an action, each action is assumed to have its own reward distribution, and it is assumed that there is at least one action that yields the highest numerical reward. As a result, the probability distribution of the rewards associated with each action is unique and unknown to the actor (decision-maker). As a result, the agent's purpose is to determine which action to do to maximize reward after a particular sequence of trials.

Exploration Vs. Exploitation in Reinforcement Learning

Exploration allows an agent to increase its current understanding of each activity, which should result in long-term advantage. Improving the accuracy of estimated action-values allows an agent to make better decisions in the future.

Exploitation, on the other hand, chooses the greedy action to maximize reward by taking advantage of the agent's present action-value estimates. However, being greedy with regard to action-value estimates may not result in the greatest payoff and may lead to suboptimal behavior. When an agent investigates, it obtains more precise estimations of action-values. If it exploits, it may receive a larger prize. It cannot, however, choose to perform both at the same time, which is known as the exploration-exploitation conundrum.

### ε-Greedy Action Selection

ε-greedy is a simple strategy for balancing exploration and exploitation that involves randomly selecting between exploration and exploitation. The ε-greedy typically exploits most of the time with a minor possibility of exploring. ε is defined as the likelihood of exploration in the algorithm. Exploration is the same as selecting a random action from action space. This is done so that the agent will try out novel actions during training in the hope that they would result in higher (future discounted) rewards. If ε=1, the agent will always explore and will never act greedily in terms of the action-value function. If ε=0, the agent will always choose the greedy action without randomly exploring other potential high-reward actions. As a result, in practice, ε maintains a reasonable balance between exploration and exploitation.

### SUMMARY

Based on the interaction with external environment and corresponding optimized action strategy, reinforcement learning (RL) has been used in many areas to solve complicated problems in both static and dynamic changing environment. After calculating reward value with current state information, the RL agent will search for next actions to improve current reward based on its exploration policy. How to select the following action impacts the convergent speed and optimal performance of the RL algorithm. As a frequently used exploration policy, the E-greedy algorithm can strike a reasonable balance between exploration and exploitation. However, for E-greedy algorithm, the approach utilized for exploration is redundant and time-consuming in some cases. The algorithm will choose actions at random throughout the searching stage, which may lengthen the search time, especially when dealing with a large action and state space. Hence, the traditional random action selection is not an effective strategy and may cause slow convergence and sub-optimal performance, which is unacceptable in most time-critical businesses.

Aspects of the invention may overcome one or more of the problems with the conventional RL algorithm by improving the performance of the RL algorithm. Some aspects may improve the performance of the conventional RL algorithm by using a value-based action selection strategy (instead of a random action selection strategy). In some aspects, the value-based action selection strategy may, at a given time instance, define and use a subset of available actions for selecting an action.

In some aspects, an action αₜ may be a vector, where each element corresponds to one dimension/feature value to select in this action (e.g., if the action is to choose a 3-D location, then, aₜ has three elements corresponding to the values in x, y, and z-axis).

In some aspects, the definition/selection of a subset of available actions at time instance t+1 may be based on the previous chosen action [symbol] . In some aspects, the definition/selection of a subset of available actions at time instance t+1 may be determined by the angle between a candidate action vector [symbol] and the previous chosen action vector [symbol] (or the dot product of the two vectors [symbol] and [symbol] In some aspects, if the previous chosen action [symbol] results in an increased value of the performance metric(s) considered in this algorithm, then the subset of available actions may include the actions αₜ that satisfy the following condition: the angle between [symbol] and [symbol] is between 0 to π/2 (or the dot product of [symbol] and [symbol] is a positive value). In some aspects, if the previous chosen action [symbol] does not result in an increased value of the performance metric(s) considered in this algorithm, the subset of available actions may include actions aₜ that satisfy the following condition: the angle between [symbol] and [symbol] is between π/2 to π(or the dot product of [symbol] and [symbol] is not a positive value). In some aspects, more generally, the angle between the candidate action vector and the previous chosen action vector can be defined as a variable or a set of thresholds, instead of being a fixed value.

In some aspects, when defining/selecting a subset of available actions at time instance t+1, the RL algorithm may consider only a subset of elements of an action [symbol] . In some aspects, this subset of elements may correspond to a group of sub-features that have inherent characteristics and/or big impact on the interested performance metrics.

For instance, assuming that (i) an action is a vector consisting of four state elements (e.g., x, y, z-axis location of a drone-base station (BS), and antenna-tilt value of the drone-BS) and (ii) only the first three elements of an action (e.g., x, y, z-axis) are used for calculating the angle or the dot product between a candidate action at time t+1 and the chosen action at time t, and thereby, used for selecting a subset of available actions at time t+1, the last element (e.g., antenna-tilt) may be used for selecting another sub-action. In some aspects, two sub-actions from two groups may be integrated together to make a decision on the action at time t+1.

In some aspects, additional information may be collected to further reduce the size of action pool and thus improve the convergent speed of the learning algorithm.

Aspects of the value-based action selection technique may provide the advantage of accelerating the solution of tough system optimization and decision-making problems in a large action and state space. When compared to choosing actions based on a uniform distribution, the value-based action selection technique may reduce the number of trials and eliminate unnecessary exploration, resulting in faster model convergence to adapt to environmental changes.

In some aspects, if the feature states are divided into one or several groups based on their inherent characteristics and corresponding impact on the interested metrics, the efficiency and performance of the algorithm may be further improved.

In some aspects, if additional information is collected, the size of the candidate action pool may be reduced, and the convergent speed of the algorithm may be improved.

One aspect of the invention may provide a method for reinforcement learning. The method may include evaluating a consequence of a previous action. The method may include, based on the evaluated consequence of the previous action, determining a subset of potential next actions. The method may include selecting an action from the determined subset of potential next actions. The method may include performing the selected action.

In some aspects, evaluating the consequence of the previous action may include performing a comparison of a set of one or more current monitored parameters to a set of one or more previous monitored parameters. In some aspects, the set of one or more current monitored parameters may include a current immediate reward, and the set of one or more previous monitored parameters may include a previous immediate reward. In some aspects, the set of one or more current monitored parameters may include an accumulated reward in a current time window, and the set of one or more previous monitored parameters may include an accumulated reward in a previous time window. In some aspects, the set of one or more current monitored parameters may include an average reward in a current time window, and the set of one or more previous monitored parameters may include an average reward in a previous time window. In some aspects, the set of one or more current monitored parameters may include one or more current key performance parameters, and the set of one or more previous monitored parameters may include one or more previous key performance parameters.

In some aspects, determining the subset of potential next actions may include determining, for each potential next action, whether a dot product of a vector for the previous action and a vector for the potential next action is greater than a threshold. In some aspects, if the evaluated consequence of the previous action is a positive consequence, the determined subset of potential next actions may include the potential next actions for which the dot product of the vector for the previous action and the vector for the potential next action is greater than the threshold. In some aspects, if the evaluated consequence of the previous action is a negative consequence, the determined subset of potential next actions may include the potential next actions for which the dot product of the vector for the previous action and the vector for the potential next action is not greater than the threshold. In some aspects, the threshold may be 0.

In some aspects, determining the subset of potential next actions may include determining, for each potential next action, whether an angle between a vector for the previous action and a vector for the potential next action is less than a threshold. In some aspects, if the evaluated consequence of the previous action is a positive consequence, the determined subset of potential next actions may include the potential next actions for which the angle between the vector for the previous action and the vector for the potential next action is less than the threshold. In some aspects, if the evaluated consequence of the previous action is a negative consequence, the determined subset of potential next actions may include the potential next actions for which the angle between the vector for the previous action and the vector for the potential next action is not less than the threshold. In some aspects, the threshold may be π/2.

In some aspects, the threshold may be a variable threshold or a threshold of a set of thresholds. In some aspects, the threshold may be determined or selected based on the evaluated consequence of the previous action.

In some aspects, the previous action and the potential next actions may include state elements, and the vectors for the previous action and the potential next actions may be based on all of the state elements. In some alternative aspects, the previous action and the potential next actions may include state elements, and the vectors for the previous action and the potential next actions may be based on a subset of the state elements. In some aspects, the subset of the state elements may include state elements that have inherent characteristics and/or a big impact on one or more performance metrics. In some aspects, the state elements may include x, y, and z-axis locations of a mobile base station (BS) and an antenna tilt value of the mobile BS, and the subset of the state elements may include the x, y, and z-axis locations.

In some aspects, the previous action and the potential next actions may include state elements, a first state element subset may include one or more but less than all of the state elements, a second state element subset may include one or more but less than of the state elements, the first and second state element subsets may be different, and determining the subset of potential next actions may include determining a subset of potential next sub-actions for the first state element subset. In some aspects, selecting an action from the determined subset of potential next actions may include: selecting a first sub-action from the subset of potential next sub-actions for the first state element subset, selecting a second sub-action from potential next sub-actions for the second state element subset, and combining at least the first and second sub-actions. In some aspects, the state elements may include x, y, and z-axis locations of a mobile base station (BS) and an antenna tilt value of the mobile BS, the first state element subset may include the x, y, and z-axis locations, and the second state element subset may include the antenna tilt value.

In some aspects, if the evaluated consequence of the previous action is a positive consequence, the determined subset of potential next actions may include only one or more potential next actions that are more likely to have a consequence that is the same as the positive consequence of the previous action than one or more potential next actions not included in the determined subset of potential next actions. In some aspects, the evaluated consequence of the previous action may be a positive consequence if a current immediate reward is greater than a previous immediate reward, an accumulated reward in a current time window is greater than an accumulated reward in a previous time window, an average reward in a current time window is greater than an average reward in a previous time window, and/or a value of one or more current key performance parameters is improved relative to a value of one or more previous key performance parameters.

In some aspects, if the evaluated consequence of the previous action is a negative consequence, the determined subset of potential next actions may include only one or more potential next actions that are more likely to have a consequence that is the opposite of the negative consequence of the previous action than one or more potential next actions not included in the determined subset of potential next actions. In some aspects, the evaluated consequence of the previous action may be a negative consequence if a current immediate reward is not greater than a previous immediate reward, an accumulated reward in a current time window is not greater than an accumulated reward in a previous time window, an average reward in a current time window is not greater than an average reward in a previous time window, and/or a value of one or more current key performance parameters is worse than a value of one or more previous key performance parameters.

In some aspects, the method may further include: sending a message to one or more external nodes to request information reporting and receiving the requested information, determining the subset of potential next actions may include using the requested information to reduce the number of potential next actions in the determined subset of potential next actions. In some aspects, the method may further include determining whether to trigger sending the message to the one or more external nodes based on a current immediate reward, an accumulated reward in a current time window, an average reward in a current time window, and/or a value of one or more current key performance parameters.

In some aspects, the method may further include evaluating a consequence of the selected action and, based on the evaluated consequence of the selected action, determining another subset of potential next actions.

Another aspect of the invention may provide a computer program including instructions that, when executed by processing circuitry of a reinforcement learning agent, causes the agent to perform the method of any of the aspects above. Still another aspect of the invention may provide a carrier containing the computer program, and the carrier may be one of an electronic signal, an optical signal, a radio signal, and a computer readable storage medium.

Yet another aspect of the invention may provide a reinforcement learning agent. The reinforcement learning agent may be configured to evaluate a consequence of a previous action. The reinforcement learning agent may be configured to, based on the evaluated consequence of the previous action, determine a subset of potential next actions. The reinforcement learning agent may be configured to select an action from the determined subset of potential next actions. The reinforcement learning agent may be configured to perform the selected action.

Still another aspect of the invention may provide a reinforcement learning, RL, agent (102). The RL agent may include processing circuitry and a memory. The memory containing instructions may be executable by the processing circuitry. The RL agent may configured to perform a process including evaluating a consequence of a previous action. The process may include, based on the evaluated consequence of the previous action, determining a subset of potential next actions. The process may include selecting an action from the determined subset of potential next actions. The process may include performing the selected action.

In some aspects, the RL agent may be further configured to perform the method of any one of aspects above.

Yet another aspect of the invention may provide any combination of the aspects set forth above.

### BRIEF DESCRIPTION OF THE DRAWINGS

The accompanying drawings, which are incorporated herein and form part of the specification, illustrate various aspects.

FIG. 1 illustrates a basic reinforcement learning framework.

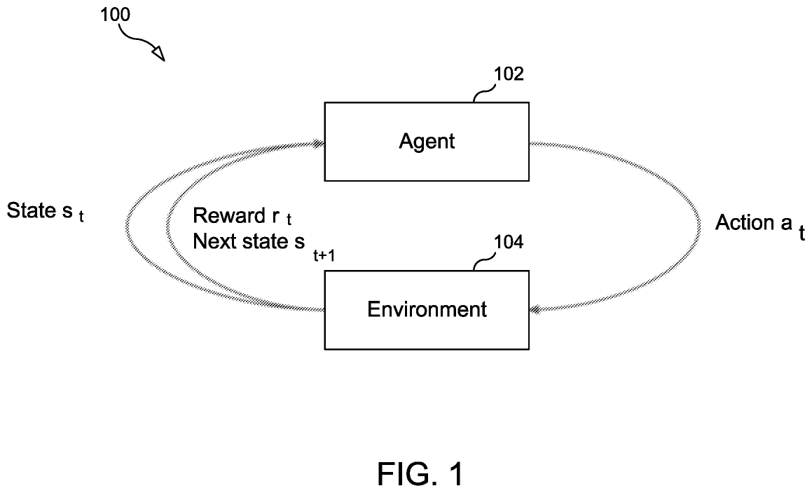

FIG. 2 illustrates the basic flow of Q-learning algorithm.

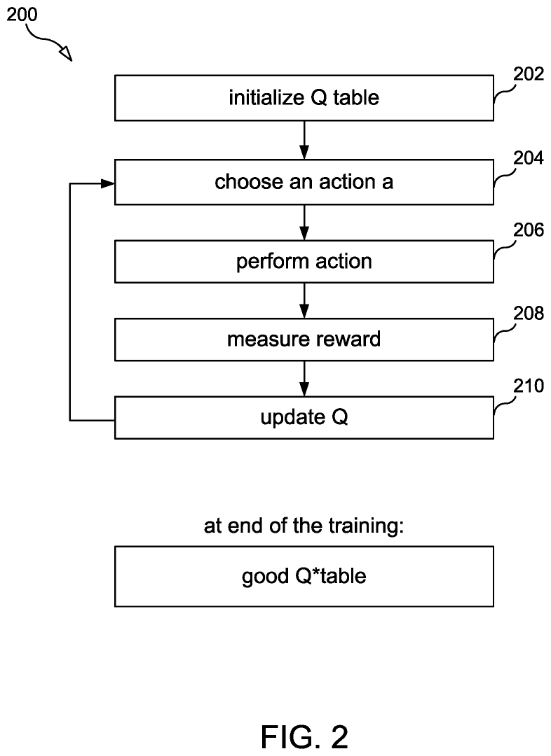

FIG. 3 illustrates a schematic of deep Q-learning.

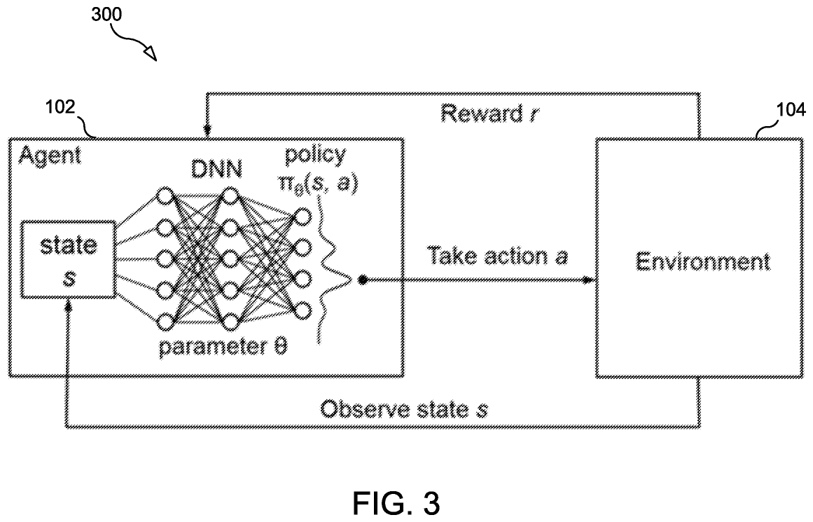

FIG. 4 illustrates a diagram of a possible set of next actions with the same or opposite consequences according to some aspects.

FIG. 5 is a chart showing learning convergence with the number of training iterations for both (i) a value-based action selection exploration strategy according to some aspects and (ii) an old exploration policy that selects actions based on a uniform distribution.

FIG. 6 is a chart showing learning convergence with the number of training iterations in a dynamic environment for both (i) a value-based action selection exploration strategy according to some aspects and (ii) an old exploration policy that selects actions based on a uniform distribution.

FIG. 7 is a flowchart illustrating a process according to some aspects.

FIG. 8 is a block diagram of an RL agent according to some aspects.

### DETAILED DESCRIPTION

Aspects of the present invention relate to a value-based action selection strategy, which may be applied in an E-greedy searching algorithm. In some aspects, the value-based action selection strategy may enable fast convergence and optimized performance (e.g., especially when dealing with large action and state space). In some aspects, the algorithm may include:
(i) monitoring a set of parameters reflecting critical system performance;
(ii) based on a set of current or previous performance metrics, evaluating the consequences which are caused by previous action; and/or
(iii) based on the semi-greedy exploration probability, selecting the action set which will potentially result in positive consequence.

In some aspects, by grouping the feature states based on their inherent characteristics and corresponding impact on the interested metrics, the algorithm may perform several independent value-based action selection procedures and integrate all the results to make a joint decision on how to select the next action to optimize the system performance. In some aspects, extra information may be collected to reduce the candidate action pool to further improve the convergent speed.

### Set of Monitored Parameters

In some aspects, the set of monitored parameters may include performance related metrics. In some aspects, the set of monitored parameters may include: (i) the received immediate reward rₜ at a given time t, (ii) the accumulated reward during a time window, (iii) the average reward during a time window, and/or (iv) key performance parameters. In some aspects, the time window (e.g., for the accumulated reward and/or for the average reward) may be from time i to time j.

In some aspects, the accumulated reward may be calculated as Σₜ₌ᵢ^{j}rₜ. In some aspects, the average reward may be calculated as

$$\frac{1}{j - i + 1} {\sum }_{t = i}^{j} {r}_{t} .$$

In some aspects, the time window (e.g., for the accumulated reward and/or for the average reward) may be decided based on the correlation time (changing-scale) of the environment. In some aspects, the time window may additionally or alternatively be decided based on the application requirements (e.g., the maximum allowed service interruption time). In some aspects, the time window may additionally or alternatively be the time duration from the beginning until the current time. In some aspects in which the set of monitored parameters include the accumulated reward and the average reward, the same time window may be used for the accumulated reward and the average reward, or different time windows may be used for the accumulated reward and the average reward.

In some aspects, the key performance parameters may include, for example and without limitation, (i) the energy consumption of the agent, which may be impacted by the convergence rate of the algorithm, and/or (ii) the overall system performance metrics or individual performance metrics for single nodes, which may be impacted by the decision of the agent.

### Definition of Positive Consequence

In some aspects, when selecting the next action during the convergent procedure of the reinforcement learning (RL) algorithm, the decision may be made based on the results of whether the selected action can provide positive consequence. In some aspects, the definition of positive consequence may be determined by: (i) the current immediate reward rₜ being larger than previous immediate reward rₜ₋₁, (ii) the accumulated reward in the current time window [i, j] being larger than the accumulated reward in the previous time window [i-k, j-k] (e.g., j-k Σₜ₌ᵢ^{j}rₜ being larger than Σₜ₌ᵢ^{j}rₜ, where k<<j), (iii) the average reward in the current time window [i, j] being larger than the average reward in the previous time window [i−k, j−k] (i.e.,

$$\frac{1}{j - i + 1} {\sum }_{t = i}^{j} {r}_{t}$$

being larger than

$$\frac{1}{j - i + 1} {\sum }_{t = i - k}^{j - k} {r}_{t} ,$$

where k<i<j), and/or (iv) the value of one or a combination of current key performance parameters being larger than the one or the combination of current key performance parameters being of the previous time window.

### Definition of Action Vector

In some aspects, a state of an agent 102 at a given time t may have two or more dimensions. For example, in some aspects, an agent's state at a given time instance t may have three dimensions, which may be denoted as sₜ={xₜ, yₜ, zₜ}, where {xₜ, yₜ, zₜ} denotes the 3-D location of the agent at time t. In some aspects, the candidate values for the three axes may be, for example, [−350, −175, 0, +175, +350] meters.

In some aspects, for each state dimension, the agent 102 may select an action out of three candidate options. In some aspects, the three alternative action options may be coded by three digits {−1, 0, 1}, where “−1” denotes the agent 102 reducing the status value by one step from its current value, “0” denotes the agent 102 not taking any action at this state dimension and keeping the current value, and “1” denotes that the agent 102 increasing the status value by one step from its current value. For instance, in some aspects, if the agent 102 is at the space point where the value of the x dimension is equal to 0 meters, then an action coded by “−1” for this dimension may denote that the agent 102 will reduce the value of the x axis to −175 meters, an action coded by “0” denotes that the agent 102 will hold the current value of x axis at 0 meters, and an action coded by “1” may denote that the agent 102 will increase the value of x axis to 175 meters. In some aspects, the same policy may be used for all the dimensions of the state space. In some aspects, if one state has three dimensions, and each state dimension has three action options, then the action pool may contain in total 27 action candidates that can be programmed to a list of the action space [(−1, −1, −1), (−1, −1, 0), (−1, −1, 1), . . . (1, 1, 1)]. Each element in this list may be regarded as an action vector.

### Action Selection

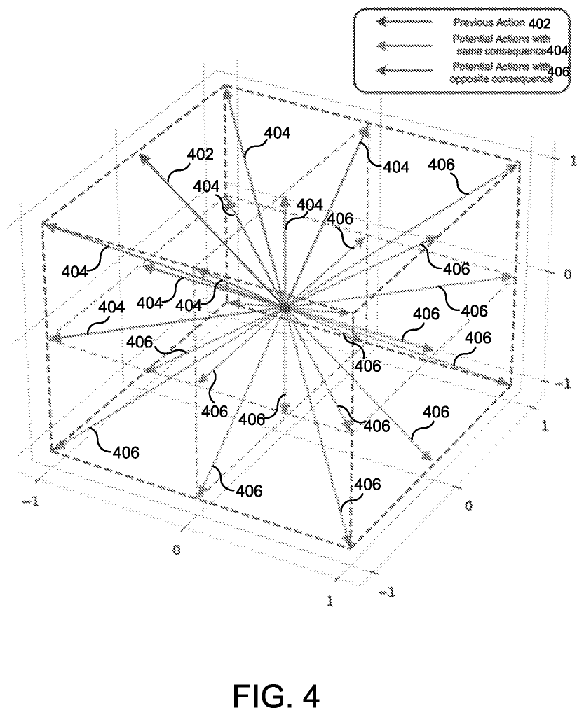

FIG. 4 depicts a possible set of next actions according to some aspects. In some aspects, the possible set of next actions may include potential next actions 404 that are likely to have the same consequence as the previous action 402 and potential next actions 406 that are likely to have the opposite consequence of the previous action 402. In some aspects, the consequence may be defined as the reward value (or monitored performance metrics) change after an action has been executed. In some aspects, the algorithm may analyze the outcome of past actions. For example, in some aspects, if the prior action decision has a positive outcome (e.g., the reward value increases or the monitored performance metrics become better), the algorithm may choose actions from a pool of alternative following actions 404 with the same consequence. In some aspects, if the angle between [symbol] and [symbol] is between 0 to π/2 (or the dot product of [symbol] and [symbol] is a positive value), the action vector [symbol] may be assumed to have the same outcome as the prior action option [symbol] . In some aspects, if the previous action decision results in a negative consequence (e.g., the reward value decreases or the monitored performance metrics become worse), the algorithm may select actions from a pool of alternative potential next actions 406 with the opposite consequence. In some aspects, potential next actions with the opposite consequence may be those in which the angle between [symbol] and [symbol] is between π/2 to π(or the dot product of [symbol] and [symbol] is not a positive value). In some aspects, the actions in this pool may be assumed to result in an opposite consequence compared with the previous action decision. In some aspects, if the previous action vector is [symbol] while the next potential action vector is [symbol] :

$$\{ \begin{matrix}\vec{{a}_{t}} \cdot \vec{{a}_{t + 1}} > 0 & ( Same consequence as the previous action selection ) \\ \vec{{a}_{t}} \cdot \vec{{a}_{t + 1}} \leq 0 & ( Opposite consequence as the previous action selection )\end{matrix}$$

FIG. 4 illustrates an example of the potential set of next actions with same or opposite consequence when the angle threshold has been set to π/2. In FIG. 4, the vector 402 represent the previous action decision, the vectors 404 are the actions that may result in the same consequence as the vector 402, and the vectors 406 are the action vectors that may result in the opposite consequence as the vector 402.

In some alternative aspects, the threshold for action grouping may be an algorithmic parameter (instead of fixing it to an angle of, for example, π/2 or a dot product value of, for example, 0). In some aspects, with the dot product value taken as an example, the next action vector [symbol] may be grouped based on whether the dot product of [symbol] and [symbol] is greater than a threshold value β.

$$\{ \begin{matrix}\vec{{a}_{t}} \cdot \vec{{a}_{t + 1}} > β \\ \vec{{a}_{t}} \cdot \vec{{a}_{t + 1}} \leq β\end{matrix}$$

In some aspects, a set of thresholds βₙ, n=1, . . . , N−1, may be used. In some aspects, action group 1 may include actions [symbol] that satisfy that [symbol] · [symbol] ≤β₁, action group n, n=2, . . . , N−1, may include actions [symbol] that satisfy that βₙ< [symbol] · [symbol] <βₙ₊₁, and action group N may include actions [symbol] that satisfy [symbol] · [symbol] >β_{N-1}.

In some alternative aspects, the next action vector [symbol] may instead be grouped based on whether the angle θ between [symbol] and [symbol] is less than a threshold value γ.

$$\{ \begin{matrix}\vec{{a}_{t}} \cdot \vec{{a}_{t + 1}} > γ \\ \vec{{a}_{t}} \cdot \vec{{a}_{t + 1}} \leq γ\end{matrix}$$

In some aspects, a set of thresholds γₙ, n=1, . . . , N−1, may be used. In some aspects, action group 1 may include actions [symbol] that satisfy that θ>γ₁, action group n, n=2, . . . , N−1, may include actions [symbol] that satisfy that γₙ>θ≥βₙ₊₁, and action group N may include actions [symbol] that satisfy θ<γ_{N-1}. In some aspects, the angle θ may be defined as follows.

$$θ = {cos}^{- 1} ( \frac{\vec{{a}_{t}} \cdot {\vec{a}}_{t + 1}}{‖ \vec{{a}_{t}} ‖ ‖ {\vec{a}}_{t + 1} ‖} )$$

In some aspects, the selection of which action group to utilize at time t+1 may depend on how the performance metric has changed. In some aspects, with the received immediate reward rₜ taken as an example of the performance metric, if rₜ−rₜ₋₁∈ Γₙ, where Γₙ is a value range, the algorithm may explore the actions in the action group n at time t+1. In some alternative aspects, the accumulated reward during a time window, the average reward during a time window, and/or the key performance parameters may additionally or alternatively be used as the performance metric.

In some alternative aspects, the algorithm may maintain and update a probability distribution (P₁, . . . , P_{N}) for the N action groups. At each time instant, the algorithm may choose to explore the actions in the action group n with probability pₙ. In some aspects, the probability distribution may be updated as

$${p}_{n} = \frac{1}{j - i + 1} {\sum }_{t = i}^{j} 1 ( {r}_{t} - {r}_{t - 1} ∈ {Γ}_{n} )$$

where 1 (·) is an indicator function that equals 1 if the argument is true and zero otherwise.

In some aspects, the value-based action selection algorithm may be as shown in Algorithm 1 below:

```
Algorithm 1: Deep Reinforcement Learning with value-based action selection
Initialize the agent's replay memory Buffer D to capacity N
Initialize action-value function Q with two random sets of weights θ, θ′
Set previous reward value rₚ to 0
Set grouping threshold β to 0
for Iteration = 1, M do
    for t = 1, T do
        if rₜ ≥ rₚ then
            Select a random action aₜ with probability ε from the same consequence action
            pool Aₛ
        else
            Select a random action aₜ with probability ε from the opposite consequence
            action pool Aₒ
        end if
        Otherwise, select aₜ = arg maxₐ Q(sₜ, a; θ)
        Set rₚ = rₜ
        Set the same consequence action pool Aₛ = Ø
        Set the opposite consequence action pool Aₒ = Ø
        Decode aₜ to action options in three state dimensions and execute the actions
        Collect reward rₜ and observe the agent's next state sₜ₊₁ = {xₜ₊₁, yₜ₊₁, zₜ₊₁}
        Store the state transition (sₜ, aₜ, rₜ, sₜ₊₁) in D
        for all potential next action aₜ₊₁ do
            if [symbol]   · [symbol]   > β then
                Append [symbol]   to Aₛ
            else
                Append [symbol]   to Aₒ
            end if
        end for
        Sample mini-batch of transitions (sⱼ, aⱼ, rⱼ, sⱼ₊₁) from buffer D
        if sⱼ₊₁ is terminal then
            Set yⱼ = rⱼ
        else
            Set yⱼ = rⱼ + γ maxₐ, Q(sⱼ₊₁, a′; θ′)
        end if
        Perform a gradient descent step using targets yⱼ with respect to the online
        parameters θ
        Set θ′ ← θ
    end for
end for
```

### Grouping of States

In some aspects, based on the state space of the RL algorithm, at least one or a set of states may be considered in the action selection algorithm. In some aspects, the set of states may be divided into one or several groups based on the inherent characteristics, corresponding impact on the interested metrics, and/or other predefined criterions. In some aspects, for each group, there may be one corresponding action vector as defined in the previous section. In some aspects, during the action selection algorithm, several independent action selection procedures may be executed simultaneously. In some aspects, if a group includes one or multiple states that have dominant impact on the performance metric, the RL algorithm will execute the proposed action selection algorithm. In some aspects, if a group consists of states that have limited contribution to the performance metric, the random action selection may be executed. In some aspects, the results may be integrated to make a joint decision on the next action.

For example, in some aspects, grouping may be done as follows: if an action is a vector consisting of four state elements (e.g., x, y, z-axis location of a drone-BS {x, y, z}, and antenna-tilt value of the drone-BS). The first three elements {x, y, z} may be put in one group, as they have the similar impact on the interested performance metrics. Based on this group and an action selection strategy described in the action selection section above, a subset of potential next actions may be generated by calculating the angle or the dot product between a candidate sub-action and the previous sub-action. The last element (e.g., antenna-tilt value) may be put into another group and used for selecting another sub-action on antenna-tilt. If antenna-tilt has limited impact on the interested performance metric, the algorithm may randomly select a sub-action for the next time instance. The two sub-actions from the two groups may be combined as one action for the next time instance.

### Extra Information Based Action Space Reduction

In some aspects, the searching policy may be executed only in a local node, which means there may be no communication between the local node and the external environment. In some aspects, when the local node is executing the searching policy, no extra information is needed from the external environment. In some alternative aspects, to further improve the efficiency of the proposed action selection algorithm, the size of candidate action space may be reduced by introducing extra information from external nodes. In some aspects, the local node may decide whether to trigger the extra information collection to enhance the current searching policy. In some aspects, the enhanced searching policy may be triggered by, for example and without limitation, one or a combination of the following events:
(i) the current immediate reward rₜ being lower than a predefined threshold for one or several time windows;
(ii) the accumulated reward in the current time window [i, j] (e.g., Σₜ₌ᵢ^{j}rₜ) being lower than a predefined threshold for one or several time windows;
(iii) the average reward in the current time window [i, j]

$$( e . g . , \frac{1}{j - i + 1} {\sum }_{t = i}^{j} {r}_{t} )$$

being lower than a predefined threshold for one or several time windows; and/or
(iv) the value of one or a combination of current key performance parameters being lower than a predefined threshold for one or several time windows.

In some aspects, after the enhanced searching policy is triggered, the local node may send a message to one or more external nodes to request information reporting. In some aspects, after this information is collected and integrated at the local node, the searching policy may be enhanced by considering this information, and, based on this information, some actions may be removed from the candidate action space, and the searching efficiency may be improved. For instance, in some aspects, the reported information may be include interference-related parameters (e.g., transmit power of neighboring base station). In some aspects, if considering selecting the next action for the x, y, z-axis location of a drone-BS {x, y, z}, the actions that are moving towards the interfering nodes may be removed from the candidate action group. In some aspects, by applying the proposed action selection strategy and reducing the size of the candidate action group, the convergent speed of the learning algorithm may be further improved.

### Performance Evaluation

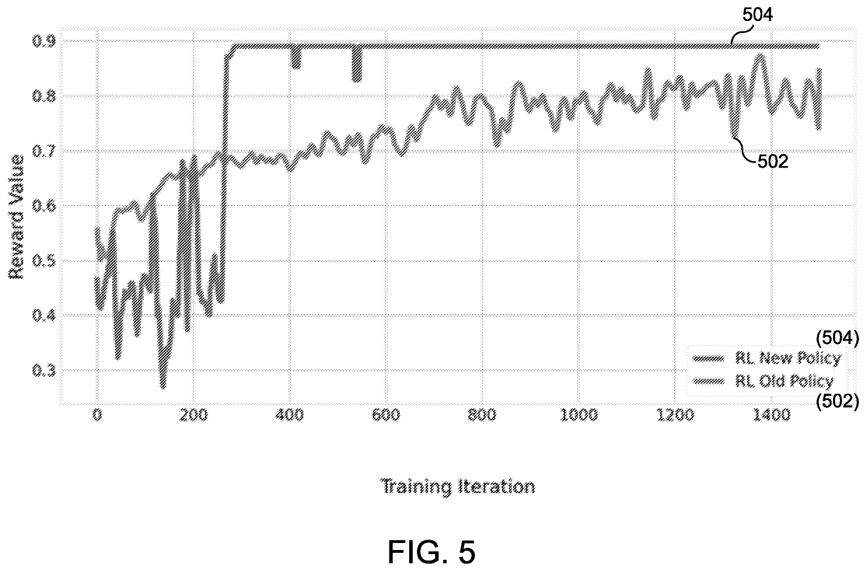

With respect to convergence in a single user distribution, FIG. 5 depicts the learning convergence of (i) a reinforcement learning system with a value-based action selection exploration strategy 504 and (ii) a reinforcement learning system with an old exploration policy 502 that selects actions based on a uniform distribution. FIG. 5 shows that a value-based action selection exploration strategy 504 can minimize learning iterations by around 80% relative to the reinforcement learning system with an old exploration policy 502. FIG. 5 also shows that the value-based action selection exploration strategy 504 is stable at the optimal state area after the line has converged.

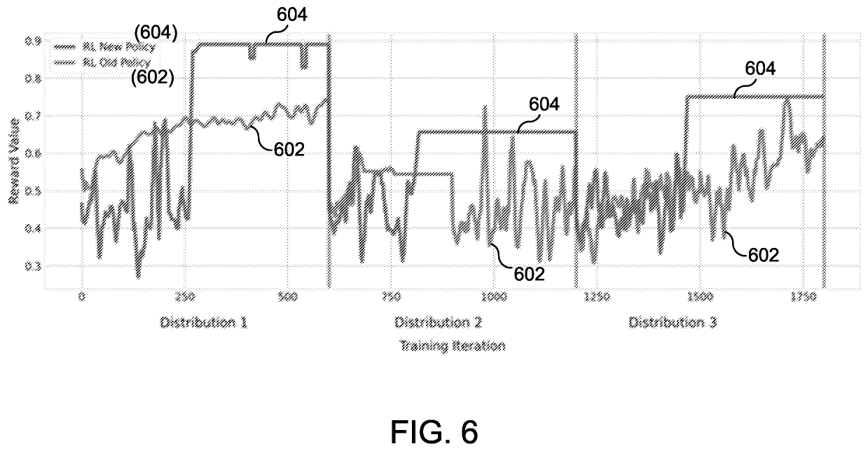

FIG. 6 depicts the learning convergence when the environment changes. FIG. 6 depicts the learning convergence of (i) a reinforcement learning system with a value-based action selection exploration strategy 604 and (ii) a reinforcement learning system with an old exploration policy 602 that selects actions based on a uniform distribution. As shown in FIG. 6, the results show that, even after changing the user distribution, the learning algorithm with a value-based action selection exploration strategy 604 may still swiftly stabilize and reach the optimal zone.

### Flowcharts

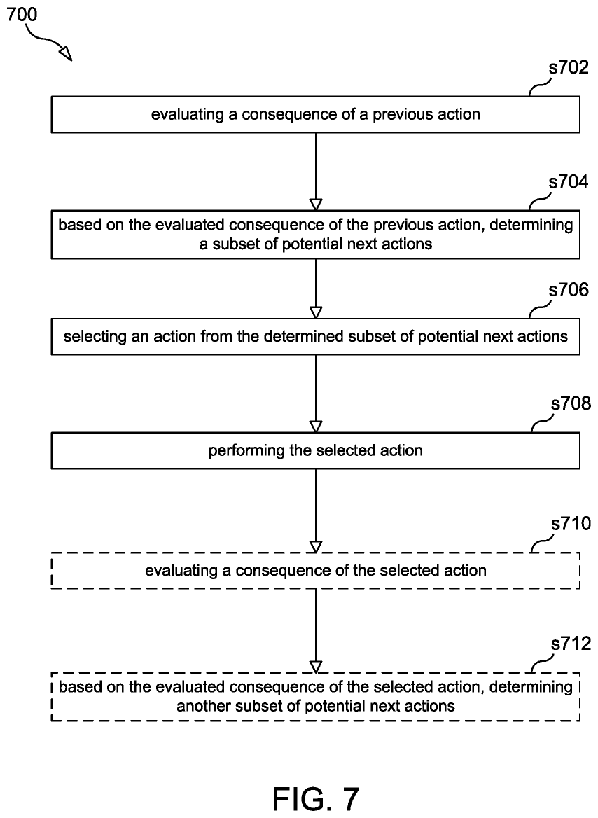

FIG. 7 illustrates a reinforcement learning process 700 according to some aspects. In some aspects, one or more steps of the process 700 may be performed by an RL agent 102. In some aspects, the RL agent 102 may include a deep neural network (DNN).

In some aspects, as shown in FIG. 7, the process 700 may include a step 702 in which the RL agent 102 evaluates a consequence of a previous action. In some aspects, evaluating the consequence of the previous action in step 702 may include performing a comparison of a set of one or more current monitored parameters to a set of one or more previous monitored parameters. In some aspects, the set of one or more current monitored parameters may include a current immediate reward, and the set of one or more previous monitored parameters may include a previous immediate reward. In some aspects, the set of one or more current monitored parameters may include an accumulated reward in a current time window, and the set of one or more previous monitored parameters may include an accumulated reward in a previous time window. In some aspects, the set of one or more current monitored parameters may include an average reward in a current time window, and the set of one or more previous monitored parameters may include an average reward in a previous time window. In some aspects, the set of one or more current monitored parameters may include one or more current key performance parameters, and the set of one or more previous monitored parameters may include one or more previous key performance parameters.

In some aspects, the consequence of the previous action may be evaluated to be a positive consequence in step 702 if a current immediate reward is greater than a previous immediate reward, an accumulated reward in a current time window is greater than an accumulated reward in a previous time window, an average reward in a current time window is greater than an average reward in a previous time window, and/or a value of one or more current key performance parameters is improved relative to a value of one or more previous key performance parameters. In some aspects, the current key performance parameters may be improved relative to the value of one or more previous key performance parameters if, for example and without limitation, a current drop rate is lower than a previous drop rate, the current energy consumption of the RL agent 102 is less than the previous energy consumption of the RL agent 102, and/or the current throughput is increased relative to the previous throughput.

In some aspects, the consequence of the previous action may be evaluated to be a negative consequence in step 702 if a current immediate reward is not greater than a previous immediate reward, an accumulated reward in a current time window is not greater than an accumulated reward in a previous time window, an average reward in a current time window is not greater than an average reward in a previous time window, and/or a value of one or more current key performance parameters is worse than a value of one or more previous key performance parameters.

In some aspects, as shown in FIG. 7, the process 700 may include a step 704 in which the RL agent 102, based on the evaluated consequence of the previous action, determines a subset of potential next actions.

In some aspects, determining the subset of potential next actions in step 704 may include determining, for each potential next action, whether a dot product of a vector for the previous action and a vector for the potential next action is greater than a threshold. In some aspects, if the evaluated consequence of the previous action is a positive consequence, the determined subset of potential next actions may include the potential next actions for which the dot product of the vector for the previous action and the vector for the potential next action is greater than the threshold. In some aspects, if the evaluated consequence of the previous action is a negative consequence, the determined subset of potential next actions may include the potential next actions for which the dot product of the vector for the previous action and the vector for the potential next action is not greater than the threshold. In some aspects, the threshold may be 0. In some alternative aspects, a different threshold (e.g., −0.5, −0.25, −0.2, −0.1, 0.1, 0.2, 0.25, or 0.5) may be used. In some aspects, the threshold may be a variable threshold or a threshold of a set of thresholds. In some aspects, the threshold may be determined or selected based on the evaluated consequence of the previous action.

In some aspects, determining the subset of potential next actions in step 704 may include determining, for each potential next action, whether an angle between a vector for the previous action and a vector for the potential next action is less than a threshold. In some aspects, if the evaluated consequence of the previous action is a positive consequence, the determined subset of potential next actions may include the potential next actions for which the angle between the vector for the previous action and the vector for the potential next action is less than the threshold. In some aspects, if the evaluated consequence of the previous action is a negative consequence, the determined subset of potential next actions may include the potential next actions for which the angle between the vector for the previous action and the vector for the potential next action is not less than the threshold. In some aspects, the threshold may be π/2. In some alternative aspects, a different threshold (e.g., π/4, 5π/8, 9π/16, 7π/16, 3π/8, or 3π/2) may be used. In some aspects, the threshold may be a variable threshold or a threshold of a set of thresholds. In some aspects, the threshold may be determined or selected based on the evaluated consequence of the previous action.

In some aspects, the previous action and the potential next actions may include state elements. In some aspects, the vectors for the previous action and the potential next actions may be based on all of the state elements. In some alternative aspects, the vectors for the previous action and the potential next actions may be based on a subset of the state elements. In some aspects, the subset of the state elements may include state elements that have inherent characteristics and/or a big impact on one or more performance metrics. In some aspects, the state elements may include x, y, and z-axis locations of a mobile base station (BS) and an antenna tilt value of the mobile BS, and the subset of the state elements may include the x, y, and z-axis locations.

In some aspects, if the consequence of the previous action is evaluated to be a positive consequence in step 702, the subset of potential next actions determined in step 704 may include only one or more potential next actions that are more likely to have a consequence that is the same as the positive consequence of the previous action than one or more potential next actions not included in the determined subset of potential next actions. In some aspects, if the consequence of the previous action is evaluated to be a negative consequence in step 702, the subset of potential next actions determined in step 704 may include only one or more potential next actions that are more likely to have a consequence that is the opposite of the negative consequence of the previous action than one or more potential next actions not included in the determined subset of potential next actions.

In some aspects, the process 700 may include an optional steps in which the RL agent 102 sends a message to one or more external nodes to request information reporting and receives the requested information. In some aspects, determining the subset of potential next actions in step 704 may include using the requested information to reduce the number of potential next actions in the determined subset of potential next actions. In some aspects, the process 700 may include an optional step in which the RL agent 102 determines whether to trigger sending the message to the one or more external nodes based on a current immediate reward, an accumulated reward in a current time window, an average reward in a current time window, and/or a value of one or more current key performance parameters.

In some aspects, as shown in FIG. 7, the process 700 may include a step 706 in which the RL agent 102 selects an action from the determined subset of potential next actions.

In some aspects, the previous action and the potential next actions may include state elements. In some aspects, determining the subset of potential next actions in step 704 may include determining the subset of potential next actions for the complete set of state elements, and selecting an action in step 706 may include selecting an action of the subset of potential next actions for the complete set of state elements. In some alternative aspects, a first state element subset may include one or more but less than all of the state elements, a second state element subset may include one or more but less than of the state elements, the first and second state element subsets may be different. In some aspects, determining the subset of potential next actions in step 704 may include determining a subset of potential next sub-actions for the first state element subset. In some aspects, selecting an action from the determined subset of potential next actions in step 706 may include: selecting a first sub-action from the subset of potential next sub-actions for the first state element subset, selecting a second sub-action from potential next sub-actions for the second state element subset, and combining at least the first and second sub-actions. In some aspects, the state elements may include x, y, and z-axis locations of a mobile base station (BS) and an antenna tilt value of the mobile BS, the first state element subset may include the x, y, and z-axis locations, and the second state element subset may include the antenna tilt value.

In some aspects, as shown in FIG. 7, the process 700 may include a step 708 in which the RL agent 102 performs the selected action.

In some aspects, as shown in FIG. 7, the process 700 may include an optional step 710 in which the RL agent 102 evaluates a consequence of the selected action. In some aspects, as shown in FIG. 7, the process 700 may include an optional step 712 in which the RL agent 102, based on the evaluated consequence of the selected action, determines another subset of potential next actions.

### Block Diagram

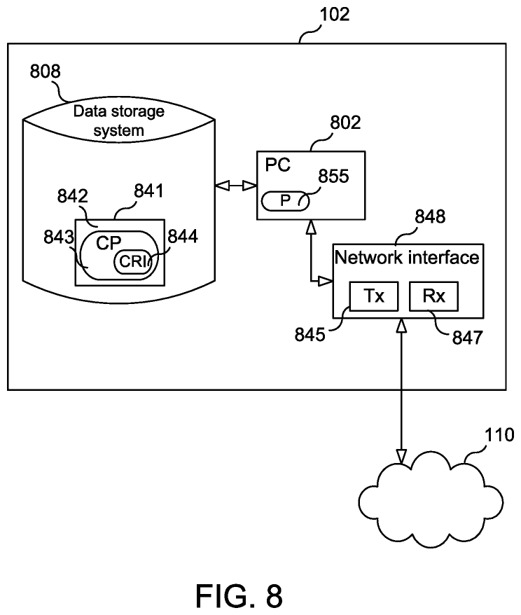

FIG. 8 is a block diagram of an RL agent 102, according to some aspects. As shown in FIG. 8, RL agent 102 may include: processing circuitry (PC) 802, which may include one or more processors (P) 855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., RL agent 102 may be a distributed computing apparatus); at least one network interface 848 comprising a transmitter (Tx) 845 and a receiver (Rx) 847 for enabling RL agent 102 to transmit data to and receive data from other nodes connected to a network 110 (e.g., an Internet Protocol (IP) network) to which network interface 848 is connected (directly or indirectly) (e.g., network interface 848 may be wirelessly connected to the network 110, in which case network interface 848 is connected to an antenna arrangement); and a storage unit (a.k.a., “data storage system”) 808, which may include one or more non-volatile storage devices and/or one or more volatile storage devices. In some alternative aspects, network interface 848 may be connected to the network 110 over a wired connection, for example over an optical fiber or a copper cable. In some aspects where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some aspects, the CRI 844 of computer program 843 is configured such that when executed by PC 802, the CRI causes RL agent 801 to perform steps of the methods described herein (e.g., steps described herein with reference to one or more of the flow charts). In some other aspects, an RL agent 102 may be configured to perform steps of the methods described herein without the need for code. That is, for example, PC 802 may consist merely of one or more ASICs. Hence, the features of the aspects described herein may be implemented in hardware and/or software.

While various aspects are described herein, it should be understood that they have been presented by way of example only, and not limitation. Thus, the breadth and scope of this disclosure should not be limited by any of the above-described exemplary aspects. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for reinforcement learning, the method comprising:
evaluating a consequence of a previous action;
based on the evaluated consequence of the previous action, determining a subset of potential next actions;
selecting an action from the determined subset of potential next actions; and
performing the selected action.

2. The method of claim 1, wherein evaluating the consequence of the previous action comprises performing a comparison of a set of one or more current monitored parameters to a set of one or more previous monitored parameters.

3-6. (canceled)

7. The method of claim 1, wherein determining the subset of potential next actions comprises determining, for each potential next action, whether a dot product of a vector for the previous action and a vector for the potential next action is greater than a threshold.

8. The method of claim 7, wherein, if the evaluated consequence of the previous action is a positive consequence, the determined subset of potential next actions comprises the potential next actions for which the dot product of the vector for the previous action and the vector for the potential next action is greater than the threshold.

9. The method of claim 7, wherein, if the evaluated consequence of the previous action is a negative consequence, the determined subset of potential next actions comprises the potential next actions for which the dot product of the vector for the previous action and the vector for the potential next action is not greater than the threshold.

10. The method of claim 7, wherein the threshold is 0.

11. The method of claim 1, wherein determining the subset of potential next actions comprises determining, for each potential next action, whether an angle between a vector for the previous action and a vector for the potential next action is less than a threshold.

12. The method of claim 11, wherein, if the evaluated consequence of the previous action is a positive consequence, the determined subset of potential next actions comprises the potential next actions for which the angle between the vector for the previous action and the vector for the potential next action is less than the threshold.

13. The method of claim 11, wherein, if the evaluated consequence of the previous action is a negative consequence, the determined subset of potential next actions comprises the potential next actions for which the angle between the vector for the previous action and the vector for the potential next action is not less than the threshold.

14. The method of claim 11, wherein the threshold is π/2.

15-16. (canceled)

17. The method of as claim 7, wherein the previous action and the potential next actions comprise state elements, and the vectors for the previous action and the potential next actions are based on all of the state elements.

18. The method of claim 7, wherein the previous action and the potential next actions comprise state elements, and the vectors for the previous action and the potential next actions are based on a subset of the state elements.

19. The method of claim 18, wherein the subset of the state elements comprise state elements that have inherent characteristics and/or a big impact on one or more performance metrics.

20. The method of claim 18, wherein the state elements comprise x, y, and z-axis locations of a mobile base station (BS) and an antenna tilt value of the mobile BS, and the subset of the state elements comprises the x, y, and z-axis locations.

21. The method of claim 18, wherein the previous action and the potential next actions comprise state elements, a first state element subset comprises one or more but less than all of the state elements, a second state element subset comprises one or more but less than of the state elements, the first and second state element subsets are different, determining the subset of potential next actions comprises determining a subset of potential next sub-actions for the first state element subset, and selecting an action from the determined subset of potential next actions comprises:
selecting a first sub-action from the subset of potential next sub-actions for the first state element subset;
selecting a second sub-action from potential next sub-actions for the second state element subset; and
combining at least the first and second sub-actions.

22. The method of claim 21, wherein the state elements comprise x, y, and z-axis locations of a mobile base station (BS) and an antenna tilt value of the mobile BS, the first state element subset comprises the x, y, and z-axis locations, and the second state element subset comprises the antenna tilt value.

23-26. (canceled)

27. The method of claim 1, further comprising:
sending a message to one or more external nodes to request information reporting; and
receiving the requested information;
wherein determining the subset of potential next actions comprises using the requested information to reduce the number of potential next actions in the determined subset of potential next actions.

28. The method of claim 27, further comprising determining whether to trigger sending the message to the one or more external nodes based on a current immediate reward, an accumulated reward in a current time window, an average reward in a current time window, and/or a value of one or more current key performance parameters.

29. The method of claim 1, further comprising:
evaluating a consequence of the selected action; and
based on the evaluated consequence of the selected action, determining another subset of potential next actions.

30-32. (canceled)

33. A reinforcement Learning (RL) agent comprising:
processing circuitry; and
a memory, the memory containing instructions executable by the processing circuitry, wherein the RL agent is configured to perform a process comprising:
evaluating a consequence of a previous action;
based on the evaluated consequence of the previous action, determining a subset of potential next actions;
selecting an action from the determined subset of potential next actions; and
performing the selected action.

34-35. (canceled)
